(19) United States
(12) Patent Application Publication
(10) Pub. No.: US 2019/0171703 A1
(43) Pub. Date: Jun. 6, 2019

(54) System and Processes for Facilitating Generation and Manipulation of Custom Products

(71) Applicant: Zelma Legal Softworks, LLC, Palm Coast, FL (US)

(72) Inventor: Ross Clayton Evans, Palm Coast, FL (US)

(21) Appl. No.: 16/207,188

(22) Filed: Dec. 2, 2018

Related U.S. Application Data
(60) Provisional application No. 62/593,989, filed on Dec. 3, 2017.

(51) Int. Cl. G06F 17/24; G06Q 30/06; G06Q 30/02

(52) U.S. Cl. CPC G06F 17/243; G06F 17/248; G06F 9/451; G06Q 30/0621; G06Q 30/02; G06Q 30/0641

(57) ABSTRACT

The present disclosure provides generally for a system that facilitates the document creation, revision, and usage process between provider and customer within the professional service industry. According to the present disclosure, a professional service provider can create templates to be sold or shared between other professional service providers or sold directly to customers. A customer can initiate a relationship by searching through available documents in a marketplace and choosing to use that document. A professional service provider can then receive the form the customer filled in and have a base for providing further professional services. A customer then has the benefit of quick, efficient service while the service provider can deliver effective service and cut down on time spent discerning and getting that information from a customer.

### CROSS-REFERENCE TO RELATED APPLICATION

This application claims priority to and the full benefit of U.S. Provisional Patent Application Ser. No. 62/593,989, filed Dec. 3, 2017, and titled “SYSTEM AND PROCESSES FOR FACILITATING GENERATION AND MANIPULATION OF CUSTOM PRODUCTS”, the entire contents of which are incorporated in this application by reference.

### BACKGROUND

Professional service providers may refer to occupations requiring special training, either in the arts or in sciences. These types of services may require professional licenses or specialized business knowledge, which may itself be broken down further by knowledge required by the industry or the investment required to gain that knowledge. These services are highly sought after and touch on a person's daily life, ranging anywhere from medical treatment to legal advice to tax advice. Individuals within these services may vary in skill, knowledge, experience, or reputation, but there is an assumption that there is a base level of competence based on external or standardized metrics and competencies.

To offset the costs of professional services, pro bono publico services, often referred to as pro bono, were offered to those who could not afford paying professionals in these fields. This offshoot focuses on providing professional work voluntarily and without payment, which may include anything from legal services to human resource services. However, there was still a gap between those who could not afford any kind of professional services and those who could not qualify for pro bono professional services because of their income level. Low bono professional services attempt to fill and meet the needs of that income gap.

In the legal profession, legal aid is an organized means for providing legal pro bono services for those otherwise unable to afford legal representation. Legal aid is at the forefront of the access to justice movement, meant to provide legal representation to those facing major life challenges, including eviction, deportation, custody battles, and domestic violence. However, most of these initiatives focus on the litigation side of the legal profession, not the transactional, or pre-lawsuit, side. Pro bono is also often not offered to those above certain income thresholds.

The legal profession has attempted to offer low bono services for those of moderate means that still cannot afford the fees private attorneys typically charge. Attorneys can use flexible pricing models, unbundle services, or operate within a limited budget where appropriate. Due to the balance between providing competent services while also making a living, attorneys try to increase the efficiency of delivering their most common services. They may even commoditize certain services, such as automating intake, creating legal guides, providing self-help kiosks, or automating documents for commonly requested documents. Despite these innovations, not every attorney is able to help every single person that walks through their door, especially if these prospective clients are unable to afford the full scope of their services. This is even more pronounced for solo practitioners or small firms, who have a particular need to balance their paid and pro bono workload.

In response to this need, there has been a proliferation of companies focused on increasing access to legal services. Online legal technology companies help customers create legal documents without needing to hire a lawyer alongside while also offering referral networks for traditional attorney services that these online legal technology companies otherwise cannot provide. This has led to discussions about the unauthorized practice of law and how best to provide effective legal services in an industry ripe for change. As this is a nascent industry, several questions are still being worked through the system. As it becomes more commonly accepted, attorneys themselves must decide how they want to integrate this reality into their practices.

On a broader scale, this proliferation may also be applied to other professional service industries and, in many cases, already has been. However, there is still a disconnect between the professional service provider and the technology facilitating access to documents. Without this control, both sides are at odds on how best to proceed.

### SUMMARY OF THE DISCLOSURE

If there was a way to integrate the professional service provider into the creation of documents, and to make it so that a professional service provider of any level could meaningfully participate in furthering their industry, there could be a major stride forward in providing meaningful access to services for individuals who could otherwise not afford them.

What is needed, therefore, is a system that allows a provider to create, package, and sell custom products of their choosing to other providers and customers complete with a streamlined means of communication between either party. Accordingly, the present disclosure relates to a system that facilitates the creation of custom documents for an interested party based on what a provider has uploaded and recommended or indicated to the system. In some aspects, a customer may choose from these uploads, input information into them, and begin a revision or review process with a provider. For example, a medical facility may have patients fill in pre-created forms that changes what questions are asked depending on what the patient says. This logic may be input directly from the medical facility side without the client knowing that they are receiving a different form based on their answers. Similarly, accountants may send simple questionnaires to their customers, wherein the answers may populate complex tax and accounting documents and forms.

Another example is to facilitate limited scope engagements in the legal community. The system may provide a means for attorneys themselves, such as solo practitioners or small firms, to provide a low-cost service that couples a reasonable time investment with a return on that investment. In some aspects, attorneys may have a platform to create, proliferate, and sell their own documents between other lawyers and clients within a marketplace. In some embodiments, clients and other attorneys may access these manufactured documents and utilize them for their own needs or in their own practice. The attorneys generating documents may provide a limited scope of representation to more clients than they might have been able to before, while allowing a marketplace to determine the strength and worth of the services they provide. In some implementations, larger organizations may also have a version of the system that is internal. In a law firm, for example, the system may be chiefly aimed at template generation and use within the hierarchy of the firm before being exchanged with clients.

A system of one or more computers may be configured to perform particular operations or actions by virtue of having software, firmware, hardware, or a combination of them installed on the system that, in operation, causes the system to perform the actions. One or more computer programs may be configured to perform particular operations or actions by virtue of including instructions that, when executed by a data processing apparatus, cause the apparatus to perform the actions. One general aspect may include a system for facilitating generation and manipulation of custom products that may include a first local computing device couplable to an internet computer network, one or more memory resources, and a remote server.

The system may include a logic option database including a plurality of logic options, where each of the plurality of logic options may provide for an input of variable responses based on predefined parameters. The system may include a format database including a plurality of formats, where each of the plurality of formats may include one or more topic to parameters, logic option parameters, and raw content parameters, a remote server coupled to one or more memory resources, and a computer network, where the remote server may be configured to communicate with a first local computing device, where communication occurs when the first local computing device is coupled to the computer network. In some implementations the system may receive a first source product including raw content of a first document, identify a first topic based on a correlation of raw content to topic parameters, identify one or more boilerplate sections based on the raw content, identify one or more variable input sections based on the raw content, associate one or more logic options with the one or more variable input sections, associate a first format with the first topic, one or more boilerplate sections, and the one or more logic options, and assimilate the first source product, where an assimilation integrates the one or more logic options, the first format, and the boilerplate sections into a first dynamic form. In some embodiments, the system may include corresponding computer systems, apparatus, and computer programs recorded on one or more computer storage devices, each configured to perform the actions of the methods.

In some aspects, system features may include where the remote server is further configured to receive customer input data in response to the one or more variable input sections. In some embodiments, the system may include where the remote server is further configured to prompt entry of customer input data in response to the one or more variable input sections. In some implementations, the system may prompt entry of customer input data in one or more graphical user interfaces that isolate the one or more variable input sections from boilerplate content proximate to the one or more variable input sections. In some embodiments, the system may prompt entry of customer input data in a graphical user interface that integrates the logic options within the first dynamic form, where the graphical user interface provides context of boilerplate content proximate to the one or more variable input sections. In some implementations, a remote server may be configured to generate a custom product and provide the custom product to a first customer. In some aspects, a remote server may be configured to identify one or more optional sections based on the raw content, where the assimilation integrates the one or more optional sections. In some embodiments, one or more optional sections may populate based on customer input data. In some implementations, a remote server may be configured to receive a plurality of source products including raw content for a plurality of documents, group a plurality of source products, where a grouping is based on similarity of topics, and create a first package including a plurality of dynamic forms. In some aspects, a portion of one or more boilerplate sections may be variable based on customer input data. In some embodiments, described techniques may include hardware, a method or process, or computer software on a computer-accessible medium, as non-limiting examples.

In some implementations, the system may include a method for facilitating generation and manipulation of custom products including method steps of: communicating with a first local computing device, where a communication occurs when the first local computing device is coupled to a computer network; receiving a first source product including raw content of a first document; identifying a first topic based on a correlation of raw content to topic parameters; identifying one or more boilerplate sections based on the raw content; identifying one or more variable input sections based on the raw content; associating one or more logic options with the one or more variable input sections; associating a first format with the first topic, one or more boilerplate sections, and the one or more logic options; and assimilating the first source product, where an assimilation integrates the one or more logic options, the first format, and the boilerplate sections into a first dynamic form. In some embodiments, the system may include corresponding computer systems, apparatus, and computer programs recorded on one or more computer storage devices, each configured to perform the actions of the methods.

In some implementations, the system may receive customer input data in response to the one or more variable input sections. In some aspects, of the system may prompt entry of customer input data in response to the one or more variable input sections. In some embodiments, the system may prompt entry of customer input data that occurs in one or more graphical user interfaces that may isolate the one or more variable input sections from boilerplate content proximate to the one or more variable input sections. In some implementations, the system may prompt entry of customer input data in a graphical user interface that integrates the logic options within the first dynamic form, where the graphical user interface provides context of boilerplate content proximate to the one or more variable input sections. In some aspects, system may generate a custom product and provide a custom product to a first customer. In some embodiments, of the system may identify one or more optional sections based on the raw content, where the assimilation integrates one or more optional sections. In some implementations, optional sections may be populated based on customer input data. In some aspects, the system may include the method steps of receiving a plurality of source products including raw content for a plurality of documents. In some embodiments, the system may include hardware, a method or process, or computer software on a computer-accessible medium.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary document management system.

FIG. 2 illustrates an exemplary internal document management system.

FIG. 3 illustrates an exemplary process flowchart for creating a custom product.

FIG. 4 illustrates an exemplary graphical user interface (GUI) for custom product generation and management by a provider.

FIG. 5 illustrates an exemplary graphical user interface (GUI) of a marketplace view.

FIG. 6 illustrates an exemplary graphical user interface (GUI) of a customer view.

FIG. 7 illustrates an exemplary graphical user interface (GUI) of a custom product generator.

FIG. 8 illustrates an exemplary graphical user interface (GUI) of a source product generator.

FIG. 9A illustrates an exemplary graphical user interface (GUI) of a product creator.

FIG. 9B illustrates an exemplary graphical user interface (GUI) of a product creator.

FIG. 10 illustrates an exemplary graphical user interface (GUI) of a package creator.

FIG. 11 illustrates an exemplary graphical user interface (GUI) of a review viewer.

FIG. 12 illustrates an exemplary graphical user interface (GUI) for product creation.

FIG. 13 illustrates an exemplary process flowchart for obtaining a custom product.

FIG. 14 illustrates an exemplary graphical user interface (GUI) for customer custom product access and management.

FIG. 15 illustrates an exemplary processing and interface system.

FIG. 16 illustrates exemplary method steps for assimilating a source product and generating a custom product.

### DETAILED DESCRIPTION

The present disclosure provides generally for a system that facilitates the document creation, revision, and usage process between provider and customer within the professional service industry. According to the present disclosure, a professional service provider may create templates to be sold or shared between other professional service providers or sold directly to customers. A customer may initiate a relationship by searching through available documents in a marketplace and choosing to use that document. A professional service provider may then receive the form the customer filled in, which may serve as a base for providing further professional services. A customer may have the benefit of quick, efficient service while the service provider may deliver effective service and cut down on time spent parsing, investigating, and getting the information from a customer.

In the following sections, detailed descriptions of examples and methods of the disclosure will be given. The description of both preferred and alternative examples, though thorough, are exemplary only, and it is understood that to those skilled in the art variations, modifications, and alterations may be apparent. It is therefore to be understood that the examples do not limit the broadness of the aspects of the underlying disclosure as defined by the claims.

Glossary:
Assimilation: as used herein refers to the process of integrating logic options into a source product.
Package: as used herein refers to a consumer-accessible item comprising a cover page, product, and back page. In some embodiments, a provider may create custom packages, wherein the provider may create each of the separate package components.
Source Product: as used herein refers to an uploaded document with raw content data from a source that may be incorporated into a package. In some aspects, the source product may integrate logic options to allow for the generation of a custom product.
Add-in: as used herein refers to a logic option prompting input of a response to a question.
Collection: as used herein refers to a logic option prompting input of a list. In some aspects, a collection may allow for the generation of bulk custom products.
For example, input of an employee list may allow for the generation of employment contracts for each employee.
Logic Option: as used herein refers to a custom product generation tool that may allow for the dynamic input of variable responses create custom documents.
Custom Product: as used herein refers to custom generated documents from a source product that is created utilizing user responses to logic options integrated into the source product.

The present disclosure relates generally to template creation and communication between parties. More specifically, the disclosure describes a system for document creation within the professional services industry that facilitates a direct link between providers and customers. In some aspects, a provider may upload template documents to be used within their industry, amongst their peers, for others within their organization, or for customers. In some implementations, a provider may upload a template document. In some embodiments, a provider may bundle many documents together within a package, such as a bundle of documents related to filing for divorce or filing tax returns.

In some implementations, a provider may assimilate their documents to create a dynamic form that may change based on customer input. In some aspects, a customer may access these documents and fill in information. In some embodiments, a customer may send these documents back to the provider for further input and feedback. In some implementations, the provider may have a one-to-one relationship with the customer to provide more customized documents. For example, a customer may have questions about the prompts, wherein direct communication between the customer and the provider may be beneficial.

In some aspects, a second provider may access the first provider's documents to use for their own customer base. In some embodiments, a second provider may use a first provider's documents as a base for further document iteration. In some implementations, the system may put a limitation on how these derivative documents are used or handled within the system. For example, a second provider may be able to use the document for his own clients but may be prevented from reselling the document to other providers.

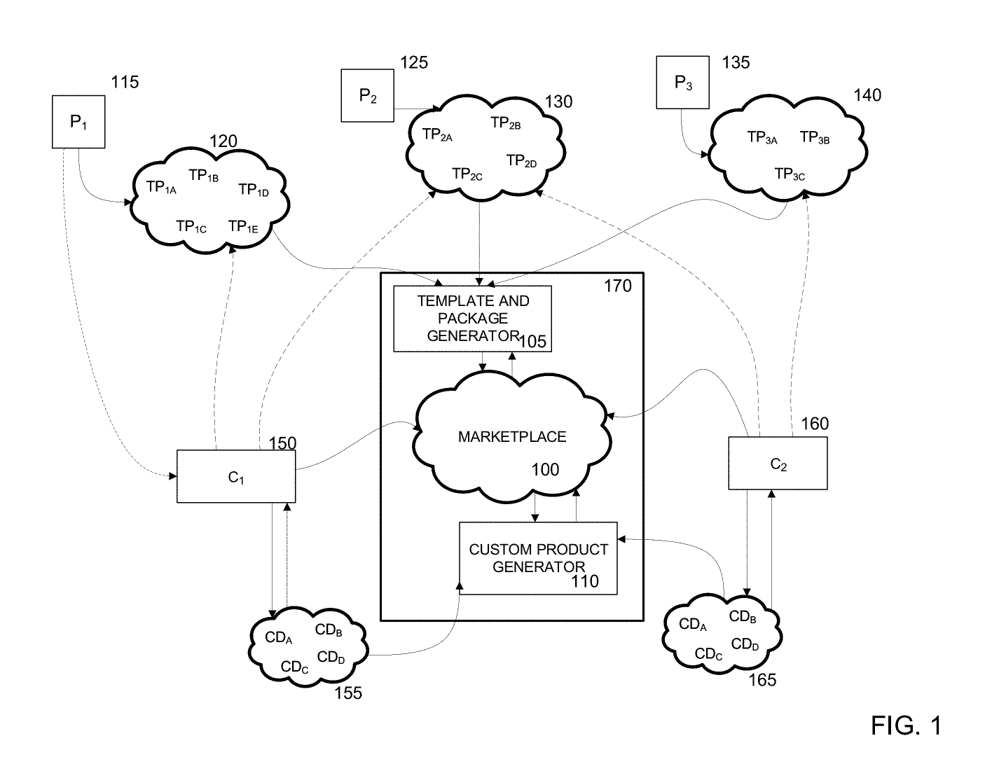

Referring now to FIG. 1, an exemplary document management system 170 is illustrated, wherein the document management system 170 may comprise a template and package generator 105, custom product generator 115, and a marketplace 100. In some embodiments, a marketplace system 100 may receive documents and data from a template and package generator system 105 and a custom product generator 110. In some embodiments, a provider 115, 125, 135 may create source products 120, 130, 140, wherein the source products 120, 130, 140 may be input into the document management system 170.

In some aspects, the source products 120, 130, 140 may relate the professional services of the providers 115, 125, 135. For example, an attorney may upload source products relating to family law, which may be their particular area of practice. In this instance, a source product may include custody forms, visitation forms, guardianship forms, support forms, and the like. By way of another example, a hospital may upload source products relating to intake, such as insurance information forms, prior medical history forms, and authorization forms.

In some embodiments, a provider 115, 125, 135 may upload a source product into the template and package generator system 105. In some implementations, the template and package generator system 105 may assimilate the source product according to the provider's direction or direct input. In some embodiments, the assimilation may occur automatically based on default settings, which may be set by a provider or by the template and package generator system, wherein the default assimilation may be further customized by the provider. In some aspects, a marketplace system 100 may receive a package. In some embodiments, the marketplace system 100 may display a package to other providers 115, 125, 135 or customers 150, 155. In some implementations, a provider 115, 125, 135 may access a package through the marketplace system 100 to add to that provider's products.

In some aspects, a customer 150, 160 may access the market place system 100. In some embodiments, a customer 150, 160 may search through products created by the template and package generator 105, such as by topic. In some implementations, a customer 150, 160 may choose between providers 115, 125, 135, wherein the customer 150, 160 may be able to review packages filtered or sorted by providers 115, 125, 135. In some aspects, a customer 150, 160 may choose from packages generated by the marketplace system 100 based on assimilated source products. In some embodiments, a customer may input customer data 155, 165 into packages, wherein the provider associated with the package may then access and review the custom products generated by the custom product generator 110 using the customer data 155, 165. In some aspects, customer data 155, 165 may include any input from the customer. For example, a customer may need to put in information about their circumstances, answer questions presented in a package, or note questions for a provider.

In some implementations, these packages may be sent to the custom product generator 110. In some aspects, the custom product generator 110 may interact with the product management system 170 to notify a provider 115, 125, 135 that a custom product has been generated. In some embodiments, the product management system 170 may notify a provider 115, 125, 135 that a custom product requires review. In some implementations, a provider 115, 125, 135 may interact directly with a customer 150, 160 once a custom product has been created.

In some aspects, a provider 115, 125, 135 and a customer 150, 160 may edit a custom product until the custom product meets a customer's needs. In some embodiments, a provider 115, 125, 135 may determine no input is needed and release a package or document for a customer's direct use. For example, a custom product may be an intake form, which a provider would not need to review and revise a customer's answers. By way of another example, there may be instances where a provider might need to follow up on the answers a customer provides in an intake form. A provider may then direct a customer to those questions requiring a more extensive response from the customer.

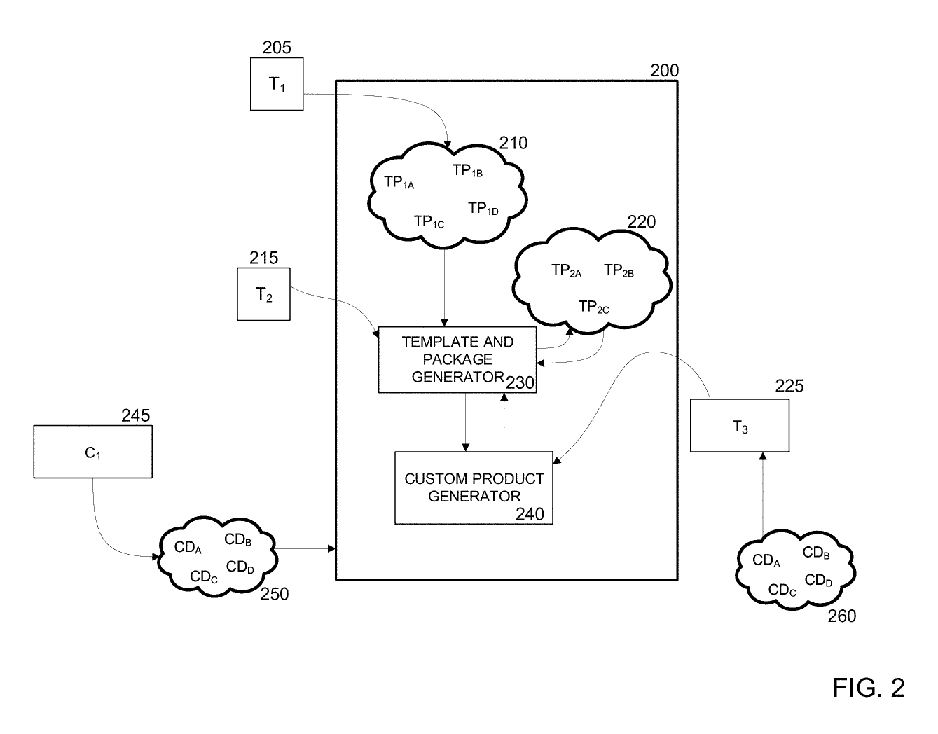

Referring now to FIG. 2, an exemplary internal document management system 200 is illustrated, wherein the internal product management system 200 may allow a provider entity to generate and manage custom products within the entity, such as a firm, hospital, or company. In some embodiments, there may be provider tiers 205, 215, 225, wherein individuals from the provider entity may have varying levels of access to the internal product management system 200. In some aspects, each provider tier 205, 215, 225 may provide different access to the functionality available within the internal document management system 200.

In some implementations, each provider tier 205, 215, 225 may provide unique access rights. In some embodiments, a higher provider tier 205, 215, 225 may allow for access rights to access those of lower provider tiers 205, 215, 225. In some aspects, each provider tier 205, 215, 225 may comprise several users within an organization. For example, an organization may designate tiers based on seniority, position, involvement in the organization, or other factors. As another example, a first provider tier within a particular organization may include senior managing partners in a law firm, who may have additional access than an associate or paralegal. As another example, a first provider tier within a particular organization may include an information technology team responsible for working with technology at a medical facility, who may have unique access when compared to medical professionals who may directly interact with patients.

In some embodiments, a first provider tier 205 may have access to the full suite of functionality in the internal document management system 200. In some implementations, a first provider tier 205 may provide access to a template and package generator 230 and a custom product generator 240. In some aspects, a first provider tier 205 may allow for the generation of source products 210, 220 to be utilized by the internal document management system 200. In some embodiments, a second provider tier 215 may only have access to packages available within the template and package generator system 230. In some aspects, the second provider tier 215 may be able to edit packages but not generate original packages. In some implementations, a third provider tier 225 may only have access to custom products within the custom product generator system 240, wherein individuals in the third provider tier 225 may be able to generate custom products but may not be able to edit or originate packages.

In some embodiments, a customer 245 may provide customer data 250, 260. In some implementations, customer data 250 may be input directly into custom products delivered by the custom product generator system 240. In some aspects, a customer 245 may only have general access to input details, without any access to the template and package generator system 230 or the custom product generator system 240. In some embodiments, customer data 260 may be input directly by the third provider tier 225. In some implementations, a third provider tier 225 may only have input access where the third provider tier 225 is responsible for inputting external data, such as, for example, that of a customer.

As an illustrative example, an internal document management system 200 may be used within a law firm. The managing partners of the firm may generate source products to be used by the rest of the firm. An associate may have access to a template bank that they can use to determine the best custom product to use with a client. An intern may only have access to the custom products and may be responsible for inputting any client information after an intake. In some cases, the entire firm may have access to an entire standardized form bank, but only certain levels of users may be able to make changes to the documents themselves. This would ensure a consistency between documents and ensuring that everyone has access to the same work product within the firm.

By way of another illustrative example, information technology or in-house counsel may have the highest access within a heavily regulated space, such as a medical facility. It is possible that a facility may want to limit physicians from making changes to documents, so while they could be considered a higher tier user, only a specific subset of a user class is able to effect change for the entire organization. This may prevent mistakes from occurring within standardized documents in the organization if someone was not trained on how to generate documents themselves. This could also ensure some sort of standardized practice by having another category of user implementing changes.

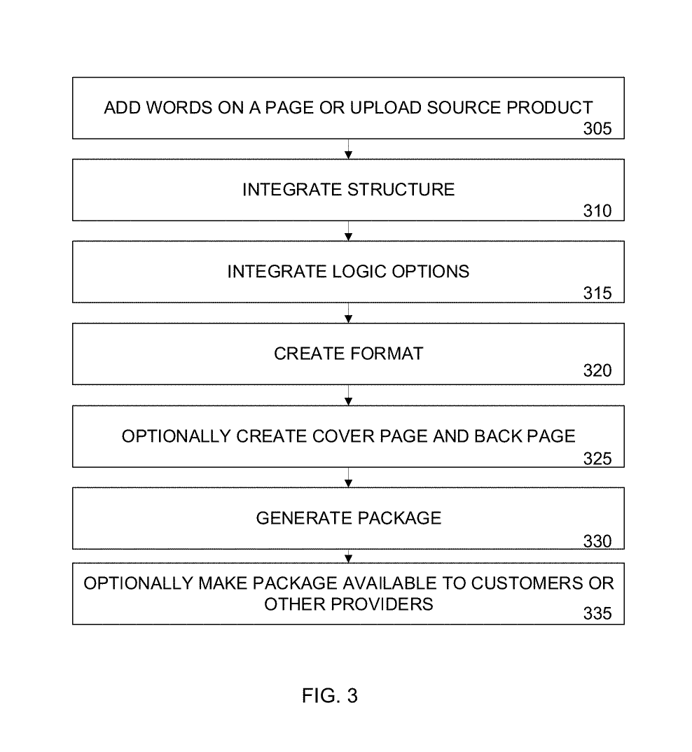

Referring now to FIG. 3, an exemplary process flowchart for creating a package is illustrated. At 305, words may be added on a page or a source product may be uploaded. In some aspects, text may be copied and pasted from an external document. In some embodiments, an entire base document may be uploaded as a source product. At 310, structure may be integrated, which may allow for sectioning of the document. At 315, logic options may be integrated, such as add-ins and collections. In some aspects, logic options may create prompts for customers to respond to, wherein the responses may be integrated into custom products. For example, add-ins may prompt a customer with a question, and collections may allow customers to input a list of details. At 320, a format may be created, wherein a provider may adjust the way the custom product will be formatted. In some embodiments, at 325, a cover page and a back page may be created. In some aspects, one or both the cover page and the back page may comprise disclaimers and details related to the provider. At 330, a package may be generated. In some implementations, at 335, a package may be made available to customers or other providers.

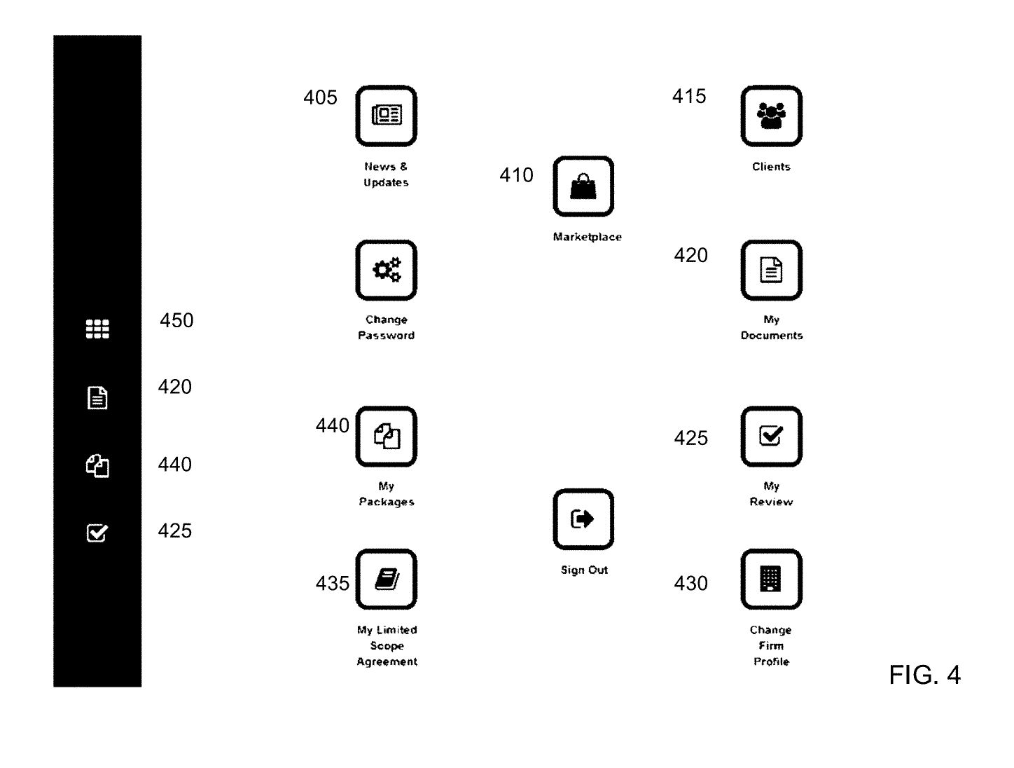

Referring now to FIG. 4, an exemplary graphical user interface (GUI) for provider custom product generation and management is illustrated. In some embodiments, a provider may click on a status icon 405 for more information about system developments, maintenance, or pre-set parameters. In some implementations, a provider may click on a marketplace icon 410 to search what custom products are available. In some aspects, the marketplace may be categorized by provider, industry, or ratings, as non-limiting examples.

In some embodiments, a provider may access insights into their own documents, which may include how many times a custom document has been viewed, how much times a custom document has been downloaded, whether there are any custom documents sitting in a customer's cart, how much time is spent reviewing or considering a custom document, whether any feedback was left regarding a document or a provider, whether the system has any recommendations for improving a document, or how many times a product has been linked to another product, as non-limiting examples.

In some implementations, a provider may click a customer icon 415 to access every person who has purchased and used a custom document. In some aspects, a provider may click a product icon 420 to view all source products and custom products that have been created. In some embodiments, a provider may assimilate documents that they upload. In some embodiments, a provider may click a review icon 425 to see all custom documents in need of more input from a customer or approval from the provider. In some implementations, a provider may approve or edit a custom document for a customer, as well as communicate with a customer with respect to their document. In some aspects, a provider may release a document for a customer once it is ready for use.

In some embodiments, a provider may click a profile icon 430 to edit information about their organization. In some implementations, this may not be an available option if an internal document management system is being used or if an organization is managing the overall system. In some aspects, a provider may click a disclaimer icon 435 to edit any disclaimers relevant to their industry. For example, an attorney may provide a limited scope agreement to a customer before they can proceed with purchasing any custom products. By way of another example, a medical facility may provide disclaimers as to the forms provided or include information that may be required by HIPAA. In some embodiments, a provider may click a packages icon 440 to create, manage, access, or upload any packages. In some aspects, a provider may click a dashboard icon 450 to return to a list of shortcuts to navigate and manage their products.

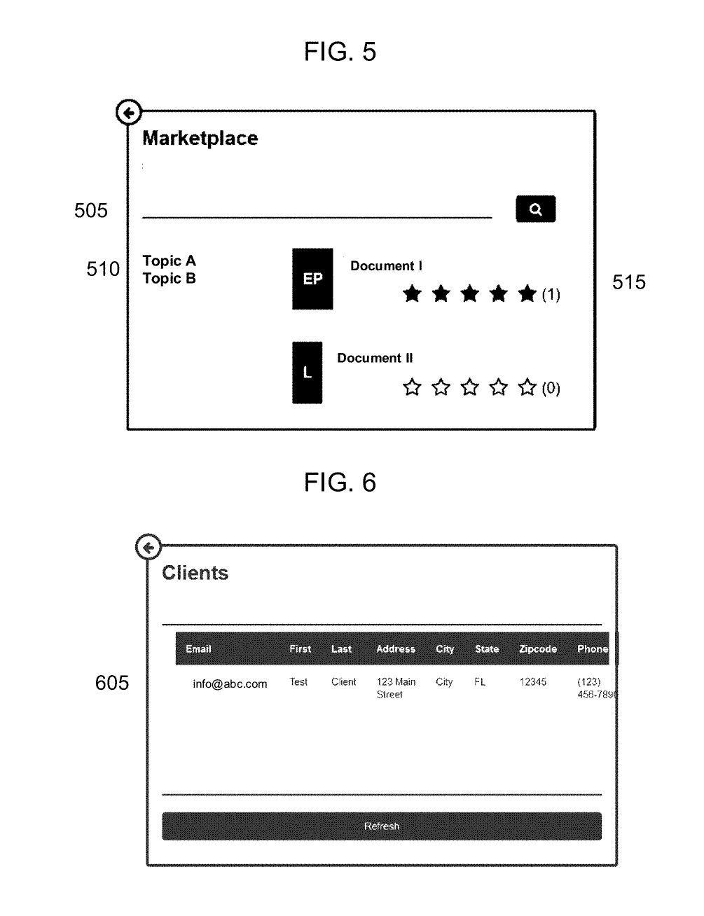

Referring now to FIG. 5, an exemplary graphical user interface (GUI) of a marketplace view is illustrated. In some embodiments, a provider may search for custom products available in the marketplace. In some implementations, a provider may use a filter toggle 510 to narrow results based on category or provider. In some aspects, a provider may click a custom product display 515 to see more information about a particular custom product. In some embodiments, a custom product display 515 may contain information such as the name of the custom product, the category for the custom product, the provider who created the custom product, and a rating for the custom product. In some implementations, a provider may see more information about the custom product, such as a preview of the custom document, what other providers thought of the document, whether any changes have been recently made to a custom product, whether there is a new version of a custom product available, what customers thought of the custom product, how long the custom product has been available, a timeline history of how a custom product was rated, and a changelog for a custom product, as non-limiting examples.

Referring now to FIG. 6, an exemplary graphical user interface (GUI) of a customer view is illustrated. In some embodiments, a provider may click a customer filter 605 to organize any customers who have purchased a custom product. In some implementations, a provider may push updates to customers who have purchased a document in the past. In some aspects, a provider may use the customer view as a customer management resource. In some embodiments, a provider may see updated customer information, such as address or phone number as a customer makes those changes in the system. In some implementations, a provider may categorize customers based on what documents they purchased or by area of interest or industry.

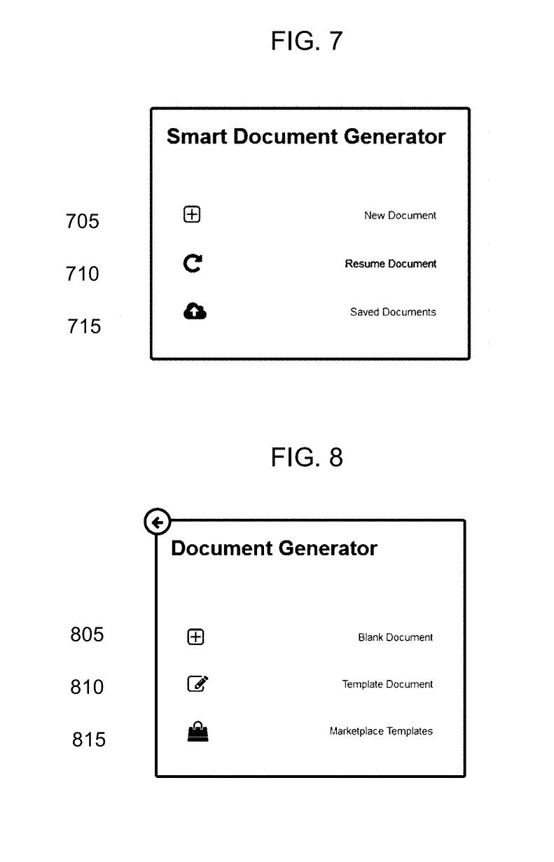

Referring now to FIG. 7, an exemplary graphical user interface (GUI) of a custom product generator is illustrated. In some embodiments, a provider may click a new source product creator icon 705. In some implementations, a provider may upload a source product. In some aspects, a provider may create a new source product within the system. In some embodiments, a provider may click a resume source product icon 710 to continue work on a source product. In some implementations, a provider may continue to integrate logic options to assimilate a source product into a custom product. In some aspects, a provider may click a saved source product icon 715 to access previously completed source products. In some embodiments, a provider may integrate more logic options or make changes to a source document. In some implementations, a provider may push an updated version of a source document to customers or other providers who purchased the custom product version of that source product.

Referring now to FIG. 8, an exemplary graphical user interface (GUI) of a source product generator is illustrated. In some embodiments, a provider may click a new source product creator icon 805. In some implementations, a provider may create a new source product within the system. In some embodiments, a provider may click a template custom product icon 810 to have a base source product to work from. In some aspects, a provider may click a marketplace template custom product icon 815 to purchase another provider's custom product. In some embodiments, a provider may choose between their own source product or a custom product purchased through the marketplace. In some implementations, a provider may customize a purchased custom product into a new source product template.

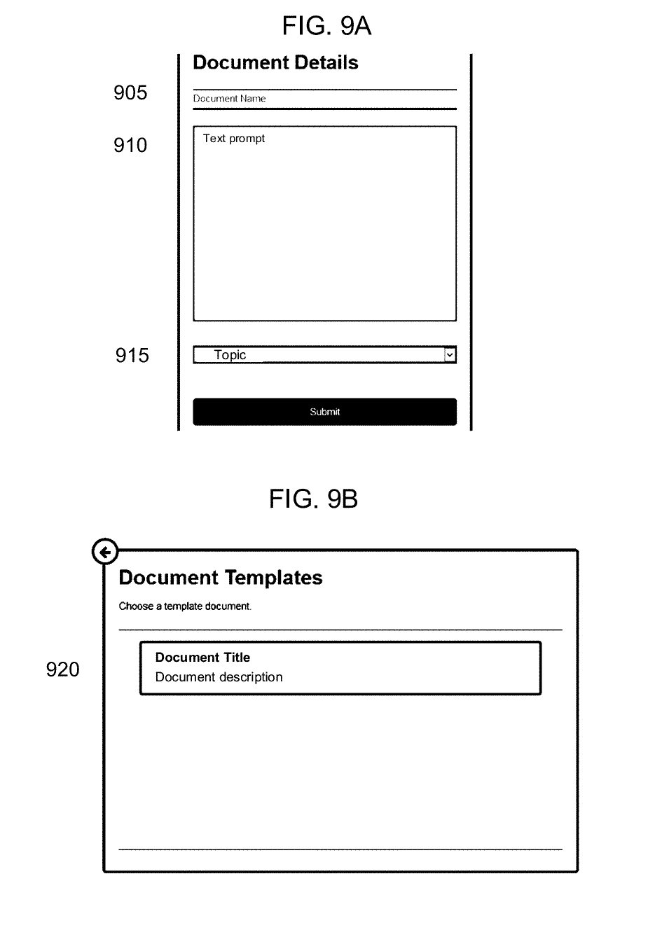

Referring now to FIGS. 9A-9B, an exemplary graphical user interface (GUI) of a product creator is illustrated. In some embodiments, a provider may name a product through a product name input 905. In some implementations, a provider may describe a product through a product description input 910. In some aspects, a provider may select a product category through a product category input 915. In some embodiments, a provider may start a product by clicking a template product selection 920. In some implementations, the system may provide indicators for whether an input has been correctly created. In some aspects, these indicators may appear when a provider submits a finished product. In some embodiments, these indicators may appear as a provider moves from input to input. In some implementations, the system may not progress until a provider supplies more information. In some aspects, a provider may save a product to complete at a later point.

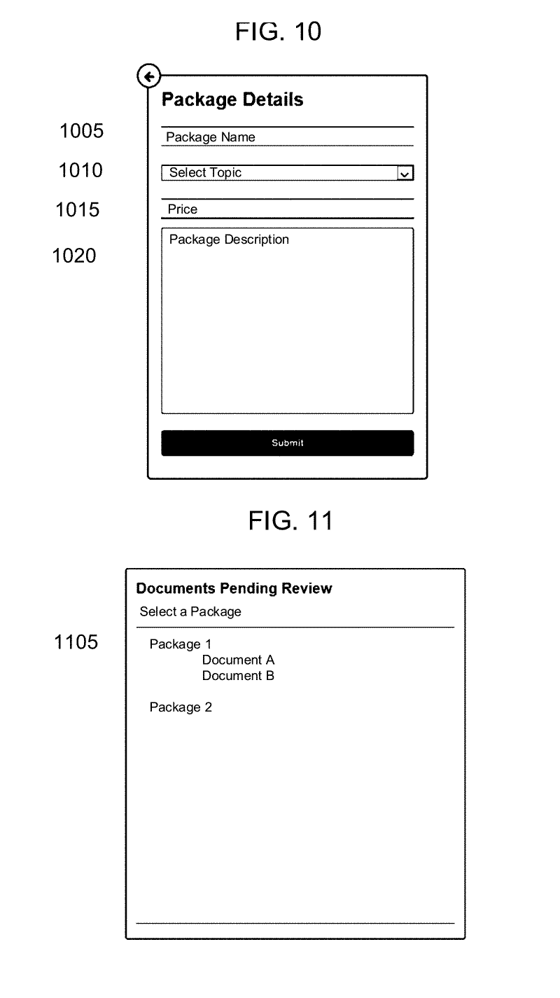

Referring now to FIG. 10, an exemplary graphical user interface (GUI) of a package creator is illustrated. In some embodiments, a provider may name a package through a package name input 1005. In some implementations, a provider may select a package category through a package category input 1010. In some aspects, a provider may create a package price through a price input 1015. In some embodiments, the package price may be pre-set by the marketplace, such as by demand or complexity of the product. In some implementations, a provider may describe a product through a package description input 1020.

In some embodiments, a package may be generated through processing multiple source products. The source products may be uploaded a processed, wherein the source products may be grouped by topic. In some implementations, customer input data may be linked through multiple source products within a package. For example, a name input may be requested once and then populate in all relevant areas throughout the package.

Referring now to FIG. 11, an exemplary graphical user interface (GUI) of a review viewer is illustrated. In some embodiments, a provider may see what products are pending review. In some implementations, a provider may select products through a review selector 1105 to see what steps are needed. In some aspects, a provider may approve a product for release. In some embodiments, a provider may request more information from a customer. In some implementations, a provider may review any comments left by a customer. In some aspects, a provider may edit a product based on customer suggestion or feedback. In some embodiments, a provider may update a version of a product through the review viewer. In some implementations, a customer may be notified of changes to a product. In some aspects, a provider may schedule a longer form review with a customer.

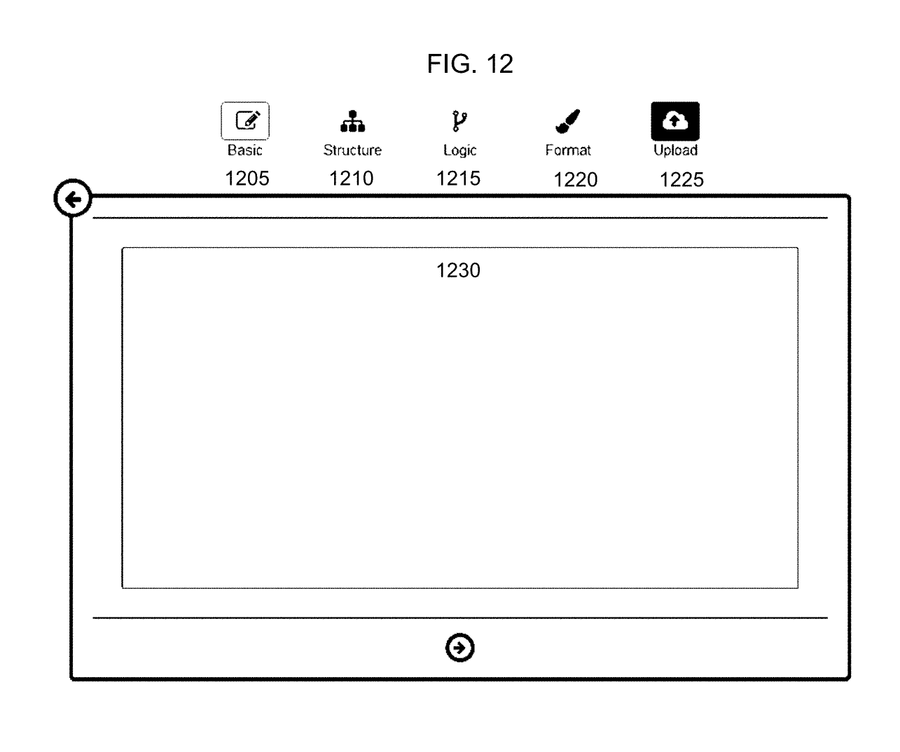

Referring now to FIG. 12, an exemplary graphical user interface (GUI) for product creation is illustrated. In some embodiments, a provider may use an information input 1230 to start creating a product. In some implementations, a provider may modify the information input 1230 by using a basic interface option 1205. In some aspects, the basic interface option may show text without any modifying features. For example, the basic interface option may show plain text on a page as written. In some implementations, the plain text may be copied from an external document or extracted from an uploaded source product.

In some embodiments, a provider may modify the information input 1230 by using a structured interface option 1210. In some implementations, the structured interface option 1210 may be used to alter how a product is displayed or divided. In some aspects, a provider may implement the structured interface option 1210 after completing a product. In some embodiments, a provider may use the structured interface option 1210 to determine how something is displayed to a customer or another provider. In some implementations, a provider may use the structured interface option 1210 to break a product into sections. In some aspects, a provider may indicate a collection point within the structured interface option 1210 for a customer to input specific information.

In some embodiments, a provider may modify the information input 1230 by using a logic interface option 1215. In some implementations, the logic interface option 1215 may be used to create branching paths within a product. In some aspects, a provider may implement the logic interface option 1215 once a product has been structured or completed. In some embodiments, a provider may implement the logic interface option 1215 once a product is completed. In some implementations, a provider may use the logic interface option 1215 to apply branching paths to inputs requested within a custom product. In some aspects, the logic interface option 1215 may be used to determine what portions of a custom product are relevant to a customer. In some embodiments, the logic interface option 1215 may be used to determine what portions of a custom product need to be displayed for a customer. In some implementations, the system may recommend certain logic options to a provider for a product.

In some embodiments, a provider may modify the information input 1230 by using a format interface option 1220. In some implementations, the format interface option 1220 may be used to change the appearance of a product. In some aspects, a provider may use the format interface option 1220 to finalize how a product will look once customer or provider-facing. In some embodiments, a provider may use the format interface option 1220 to ensure consistency throughout the document. For example, a provider may use format interface option 1220 to properly align the document, add watermarks, make sure the fonts and font sizes are all the same, or to emphasize certain portions by how they are displayed. In some implementations, the system may scan a product to ensure this consistency on behalf of the provider.

In some embodiments, a provider may use an upload option 1225 to prepare a document for the marketplace or to store within templates. In some implementations, the system may perform a final check on the product for the provider. In some aspects, the system may notify the provider if something has not been completed for the product or if a specific area needs attention. In some embodiments, the system may make recommendations for the provider based on the options available. In some implementations, a provider may indicate where they would like a product uploaded to within the system.

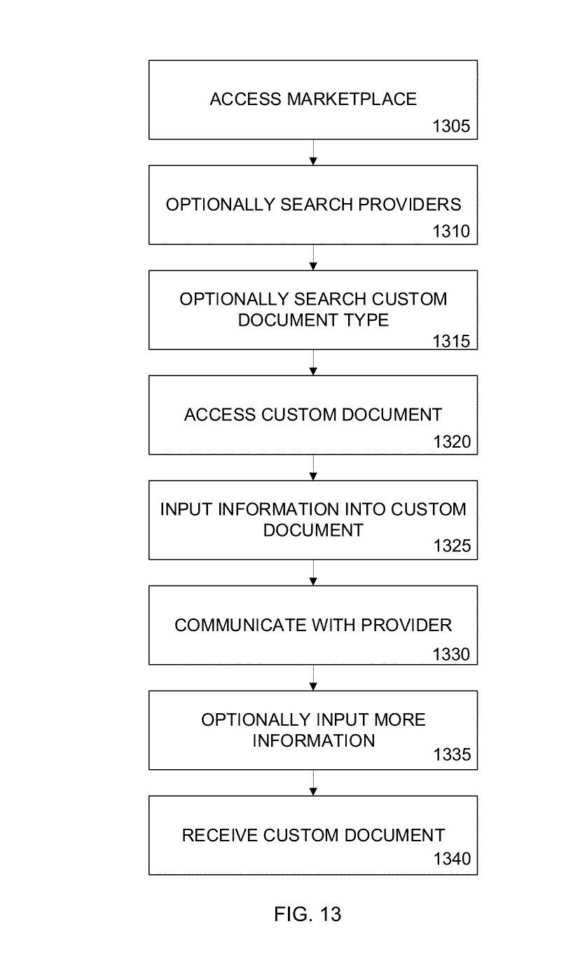

Referring now to FIG. 13, an exemplary process flowchart for obtaining a custom product is illustrated. At 1305, the marketplace may be accessed. In some embodiments, at 1310, providers may be searched, which may allow a customer to return to providers used in the past or those with positive reviews. In some implementations, at 1315, custom document types may be searched or browsed, which may allow a customer to find relevant products and packages. At 1320, custom documents may be accessed. In some embodiments, at 1320, the accessible custom documents may be samples to show what the final product may look like as a preview for a customer.

At 1325, information may be inputted into a custom document. In some implementations, at 1325, the information may be requested through a secondary or indirect form, which may be easier to complete than through direct input. At 1330, a provider may be communicated with, which may allow for direct contact for questions or more detailed feedback on any issues. For example, a customer may believe they need an asset purchase agreement but may actually need a lease agreement. Communication between the customer and the provider may allow for the provider to discern the actual needs of the customer. In some aspects, at 1335, more information may be inputted, such as where communication indicates further information may be beneficial or necessary. At 1340, a custom document may be received, wherein the custom document may include the details input at steps 1325 and 1335.

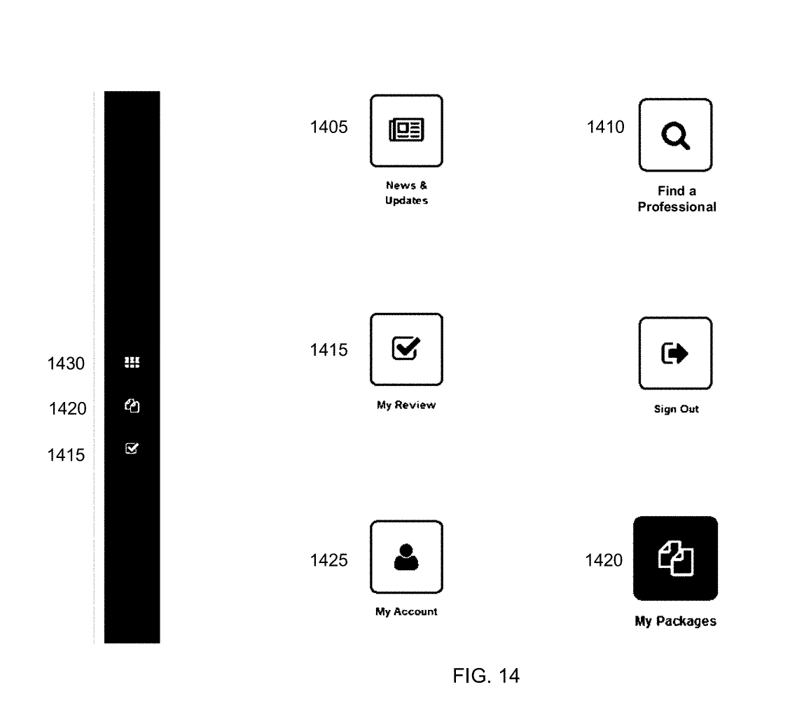

Referring now to FIG. 14, an exemplary graphical user interface (GUI) for customer custom product access and management is illustrated. In some embodiments, a customer may click on a status icon 1405 for more information about custom product developments, system maintenance, or pre-set parameters. In some implementations, a customer may click on a provider icon 1410 to search custom product providers. In some aspects, a customer may search a marketplace to see what custom products may be available. In some embodiments, the marketplace may be categorized by provider, industry, or ratings, as non-limiting examples. In some implementations, a customer may click a dashboard icon 1430 to return to a list of shortcuts to navigate their packages and custom products.

In some embodiments, a customer may click a review icon 1415 to see the status of purchased custom products. In some implementations, a customer may interact with a custom product. In some aspects, a customer may send a custom product to a provider for input. In some embodiments, a customer may receive communications from a provider. In some implementations, a customer may see notifications regarding work done on a product. In some aspects, a customer may view a timeline or estimate for when a product might be ready for them. In some embodiments, a customer may view the average time a provider takes to respond or turn around a product. In some implementations, this may be based on historical information based on the provider's actions in the past, based on ratings from other customers, or based on repeated individual interactions with that provider, as non-limiting examples. In some aspects, a customer may indicate whether there is an impending deadline for a product. In some embodiments, a provider may indicate whether there is a deadline for the customer's response.

In some implementations, a customer may click a package icon 1420 to see what packages are available to them. In some aspects, viewable packages may be completed, purchased, or pending. In some embodiments, packages may be stored for later use. In some implementations, a customer may filter available packages based on provider, product category, rating, frequency of use, or some other option. In some aspects, a customer may move a package back into the review process by re-opening a package or requesting an update from a provider. In some embodiments, the customer may set certain products to be archived after they reach a certain age or when the package falls below a certain review threshold. In some implementations, a customer may archive a package if a package is no longer regularly updated by a provider.

In some embodiments, a customer may click a profile icon 1425 to edit their personal information. In some implementations, a customer may notify providers who have products in review that their information has changed. In some aspects, the system may update the relevant fields with a customer's information if a product is pending review.

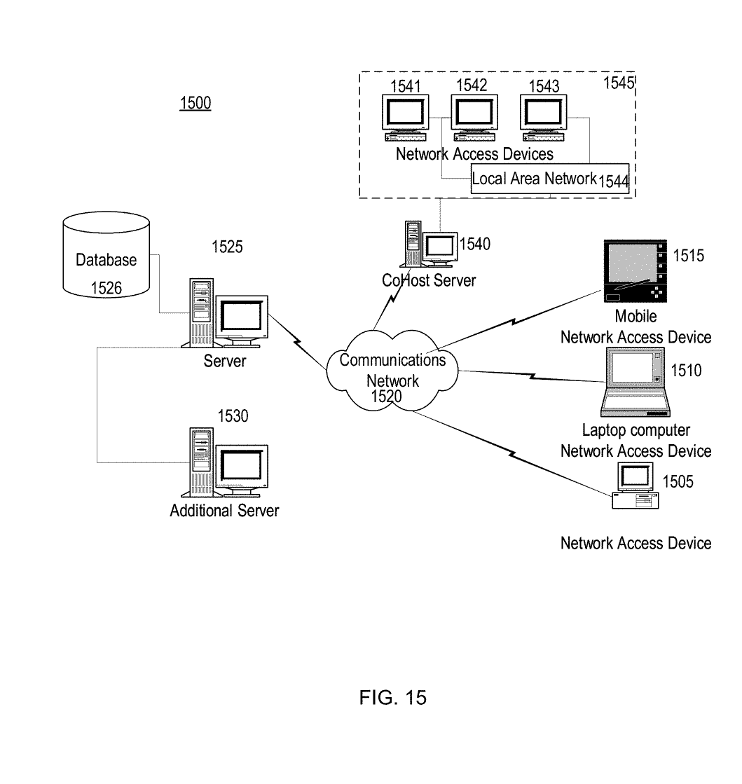

Referring now to FIG. 15, an exemplary processing and interface system 1500 is illustrated. In some aspects, access devices 1515, 1510, 1505, such as a paired portable device 1515 or laptop computer 1510 may be able to communicate with an external server 1525 though a communications network 1520. The external server 1525 may be in logical communication with a database 1526, which may comprise data related to identification information and associated profile information. In some embodiments, the server 1525 may be in logical communication with an additional server 1530, which may comprise supplemental processing capabilities.

In some aspects, the server 1525 and access devices 1505, 1510, 1515 may be able to communicate with a cohost server 1540 through a communications network 1520. The cohost server 1540 may be in logical communication with an internal network 1545 comprising network access devices 1541, 1542, 1543 and a local area network 1544. For example, the cohost server 1540 may comprise a payment service, such as PayPal or a social network, such as Facebook or LinkedIn.

In some embodiments, the database 1526 may comprise a logic option database and a format database. In some aspects, the logic option database may comprise a plurality of logic options, wherein each of the plurality of logic options may provide for input of variable responses based on predefined parameters. In some implementations, a format database comprising a plurality of formats, wherein each of the plurality of formats comprise one or more topic parameters, logic option parameters, and raw content parameters. In some aspects, the components of an assimilated source product may be stored as a collection of data unconfined to a single document. In some embodiments, once collected, customer input data may be stored separately from the source product and the custom product, which may allow for use of less data than may be required to store complete documents. In some implementations, a custom product may be generated as a document for download or viewing on demand.

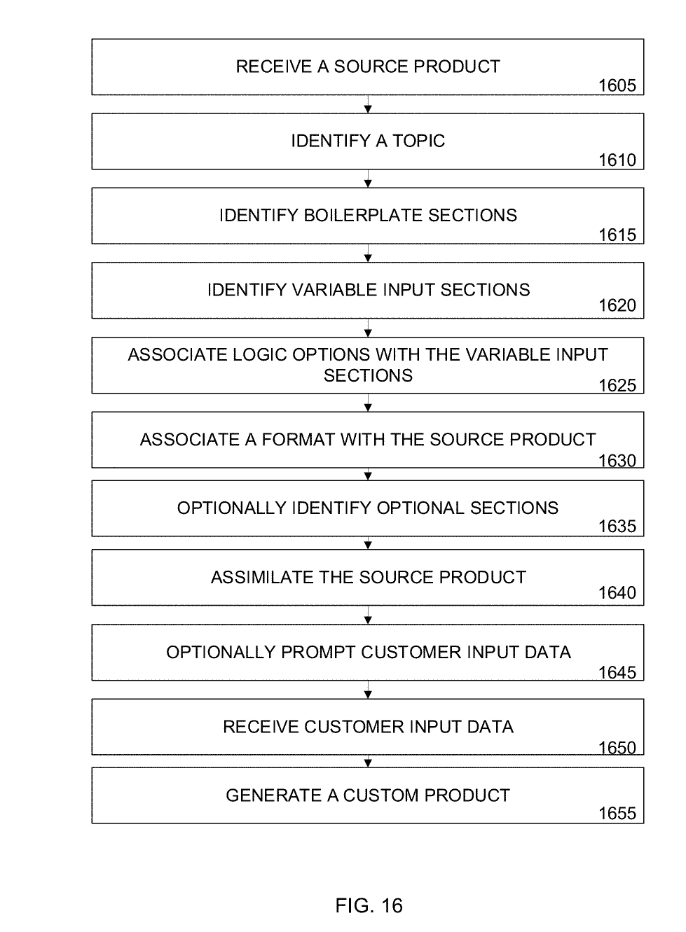

Referring now to FIG. 16, exemplary method steps for generating a custom product are illustrated. At 1605, a source product may be received, wherein the source product may comprise raw content data for a document. At 1610, a topic may be identified, wherein the topic may guide further steps of the process. For example, where the topic may relate to medical information, a clause related to legal implications may be considered boilerplate. Where the topic may relate to a legal contract, a clause with similar legal implications may be identified as a variable input section.

At 1615, boilerplate sections may be identified. In some embodiments, boilerplate sections may have limited variability, such as to change for genders, plurality, names. At 1620, variable input sections may be identified. At 1625, logic options may be associated with the variable input sections. At 1630, a format may be associated with the source product. In some embodiments, at 1635, optional sections may be identified, wherein optional sections may be relevant to a custom product depending on customer input data. For example, a section related to a spouse or children would only be relevant where there is a spouse or children.

At 1640, the source product may be assimilated, which may integrate the logic options, boilerplate sections, optional sections, and format. In some aspects, at 1645, customer input data may be prompted, such as through a local computing device. At 1650, customer input data may be received. At 1655, a custom product may be generated. In some implementations, the prompting at 1645 may occur through a one or more graphical user interfaces (GUI). In some aspects, the GUIs may be separate from surrounding contextual content, such as proximate boilerplate sections or optional sections. In some embodiments, the GUI may integrate the contextual data, such as where the customer input data is prompted within the context of proximate content.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multi-tasking and parallel processing may be advantageous. Nevertheless, it will be understood that various modifications may be made without departing from the spirit and scope of the claimed disclosure.

What is claimed is:

1. A system for facilitating generation and manipulation of custom products comprising:
a first local computing devices couplable to an internet computer network;
one or more memory resources comprising:
a logic option database comprising a plurality of logic options, wherein each of the plurality of logic options provide for input of variable responses based on predefined parameters;
a format database comprising a plurality of formats, wherein each of the plurality of formats comprise one or more topic parameters, logic option parameters, and raw content parameters;
a remote server coupled to the one or more memory resources and a computer network, wherein the remote server is configured to:
communicate with a first local computing device, wherein communication occurs when the first local computing device is coupled to the computer network;
receive a first source product comprising raw content of a first document;
identify a first topic based on a correlation of raw content to topic parameters;
identify one or more boilerplate sections based on the raw content;
identify one or more variable input sections based on the raw content;
associate one or more logic options with the one or more variable input sections;
associate a first format with the first topic, one or more boilerplate sections, and the one or more logic options; and
assimilate the first source product, wherein an assimilation integrates the one or more logic options, the first format, and the boilerplate sections into a first dynamic form.

2. The system of claim 1, wherein the remote server is further configured to receive customer input data in response to the one or more variable input sections.

3. The system of claim 2, wherein the remote server is further configured to prompt entry of customer input data in response to the one or more variable input sections.

4. The system of claim 2, wherein the remote server is further configured to:
generate a custom product; and
provide the custom product to a first customer.

5. The system of claim 2, wherein the remote server is further configured to identify one or more optional sections based on the raw content, wherein the assimilation integrates the one or more optional sections.

6. The system of claim 5, wherein the one or more optional sections populate based on customer input data.

7. The system of claim 3, wherein a prompting of the entry of customer input data occurs in one or more graphical user interfaces that isolate the one or more variable input sections from boilerplate content proximate to the one or more variable input sections.

8. The system of claim 3, wherein a prompting of the entry of customer input data occurs in a graphical user interface that integrates the logic options within the first dynamic form, wherein the graphical user interface provides context of boilerplate content proximate to the one or more variable input sections.

9. The system of claim 1, wherein the remote server is further configured to:
receive a plurality of source products comprising raw content for a plurality of documents;
group the plurality of source products, wherein a grouping is based on similarity of topics; and
create a first package comprising a plurality of dynamic forms.

10. The system of claim 1, wherein at least a portion of the one or more boilerplate sections is variable based on customer input data.

11. A method for facilitating generation and manipulation of custom products comprising the method steps of:
communicating with a first local computing device, wherein a communication occurs when the first local computing device is coupled to a computer network;
receiving a first source product comprising raw content of a first document;
identifying a first topic based on a correlation of raw content to topic parameters;
identifying one or more boilerplate sections based on the raw content;
identifying one or more variable input sections based on the raw content;
associating one or more logic options with the one or more variable input sections;
associating a first format with the first topic, one or more boilerplate sections, and the one or more logic options; and
assimilating the first source product, wherein an assimilation integrates the one or more logic options, the first format, and the boilerplate sections into a first dynamic form.

12. The method of claim 11, further comprising the method step of receiving customer input data in response to the one or more variable input sections.

13. The method of claim 12, further comprising the method step of prompting entry of customer input data in response to the one or more variable input sections.

14. The method of claim 12, further comprising the method steps of:
generating a custom product; and
providing the custom product to a first customer.

15. The method of claim 12, further comprising the method step of identifying one or more optional sections based on the raw content, wherein the assimilation integrates the one or more optional sections.

16. The method of claim 15, wherein the one or more optional sections populate based on customer input data.

17. The method of claim 13, wherein the prompting of the entry of customer input data occurs in one or more graphical user interfaces that isolate the one or more variable input sections from boilerplate content proximate to the one or more variable input sections.

18. The method of claim 13, wherein the prompting of the entry of customer input data occurs in a graphical user interface that integrates the logic options within the first dynamic form, wherein the graphical user interface provides context of boilerplate content proximate to the one or more variable input sections.

19. The method of claim 12, further comprising the method steps of:
receiving a plurality of source products comprising raw content for a plurality of documents;
grouping the plurality of source products, wherein a grouping is based on similarity of topics; and
creating a first package comprising a plurality of dynamic forms.

20. The method of claim 12, wherein at least a portion of the one or more boilerplate sections is variable based on customer input data.
